(19) United States
(12) Patent Application Publication
(10) Pub. No.: US 2002/0178286 A1
(43) Pub. Date: Nov. 28, 2002

(54) Video file transfer network

(76) Inventors: Roger Booker, Durham, NH (US); Keith George, Barrington, NH (US); Charles Townsend, Dover, NH (US); Richard Kunis, Danville, NH (US); John Blackwell, Northwood, NH (US)

Correspondence Address: BANNER & WITCOFF, LTD., TEN SOUTH WACKER DRIVE, SUITE 3000, CHICAGO, IL, 60606, US

(21) Appl. No.: 09/864,090

(22) Filed: May 23, 2001

(51) Int. Cl. G06F 15/173

(52) U.S. Cl. 709/239; 709/219

(57) ABSTRACT

A method of transmitting files from a remote source to a computer is provided. The computer is connected to a local area network (LAN) and an alternative transmission path. The alternative transmission path can include a video server and a broadband switch. Both the LAN and the alternative path are connected to a common router. The router includes bypass logic for routing the file to the computer either through the LAN or the alternative path. The alternative path can be used for the transmission of large files to prevent overloading the LAN.

### FIELD OF THE INVENTION

The present invention relates to networks used to transfer video files. More specifically, the present invention is directed to a network configuration that includes an optional path for sending and receiving video files.

### BACKGROUND OF THE INVENTION

FIG. 1 shows a conventional computer network configuration used to retrieve video files. Computers 102, 104 and 106 are connected to each other through a local area network (LAN) 108. A LAN hub 110 connects the computers to a router 112, which connects LAN hub 110 to a wide area network (WAN) 114. A plurality of additional LANs and computers can also be connected to WAN 114. FIG. 1 shows a video source computer 116 connected to WAN 114.

To retrieve a video file from video source computer 11 6, computer 102 sends a request to video source computer 116 through LAN 108, router 112 and WAN 114. The video file is then sent from video source computer 116 to computer 102 through the same path. Local area networks, such as LAN 108, generally have a common bus that is shared by all the computers connected to the LAN for sending and receiving digital files. When computer 102 receives a large file, such as a video file, computers 104 and 106 may suffer from a slowdown when accessing the network while the file is being transferred. As a result, the transfer of a large file to a single computer connected to a LAN can limit the ability of other computers connected to the LAN to perform such functions as sending and receiving e-mail and browsing the Internet.

Accordingly, there exists a need in the art for a computer network configuration that allows computers connect to a LAN to retrieve large files without degrading the overall performance of the LAN.

### SUMMARY OF THE INVENTION

The present invention provides a computer network and networking method that allows for the transfer of large files to computers connected to a LAN without limiting the ability of additional computers connected to the LAN from utilizing the LAN. The advantages of the present invention are provided by a computer network that includes a computer that transmits requests for digital files across a local area network to a router and an alternate transmission path between the router and the computer that does not include the local area network. The router receives the requested digital files and is programmed to route a first group of digital files through the local area network to the computer and to route a second group of digital files through at least a portion of the alternate transmission path.

In one embodiment of the invention, a user of the invention determines which digital files belong in the first group and which digital files belong in the second group. Alternatively, the router includes computer executable instructions for determining which digital files belong in the first group and which digital files belong in the second group. The determination can be based on the size of each digital file, a traffic condition of the local area network or the time of day.

In another embodiment of the invention, the advantages of the present invention are provided by a method of requesting and receiving a file from a remote source connected to a wide area network. The method includes the steps of transmitting a request for the file from a computer device to a router via a local area network, receiving the file at the router and transmitting the file from the router to the computer via a path that does not include the local area network.

In yet another embodiment of the invention, a method of transmitting digital files between computers is provided. The method includes the steps of transmitting a request for a file from a first computer to a second computer using a mail transfer protocol and, in response to the request, transmitting the requested file from the second computer using a file transfer protocol.

### BRIEF DESCRIPTION OF THE DRAWINGS

The present invention is illustrated by way of example and not limited in the accompanying figures in which like reference numerals indicate similar elements and in which:

FIG. 1 is a schematic diagram of a conventional computer network configuration;

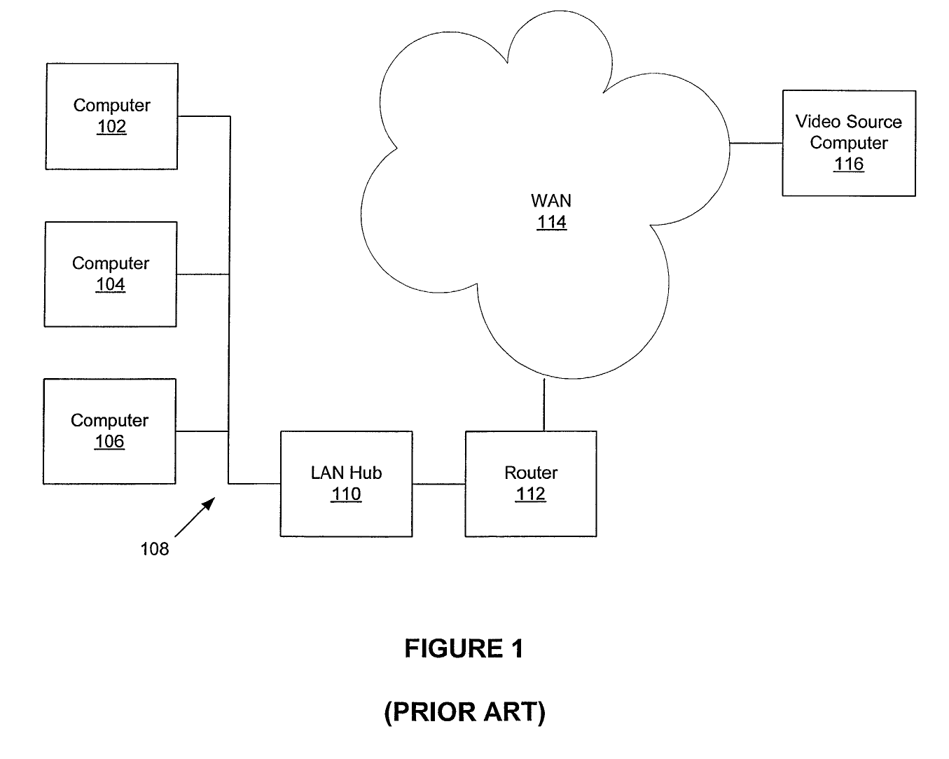

FIG. 2a is a schematic diagram of a computer network configuration suitable for transferring large files in accordance with an embodiment of the present invention;

FIG. 2b is a schematic diagram of a computer network configuration that includes a broadband switch that is suitable for transferring large files in accordance with an embodiment of the present invention;

FIG. 3 shows a method of downloading a large file in accordance with an embodiment of the invention;

FIG. 4 shows a web page that can be used to request the transfer of video files in accordance with an embodiment of the invention; and

FIG. 5 is a diagram showing a process for sending files between video servers.

### DETAILED DESCRIPTION OF PREFERRED EMBODIMENTS

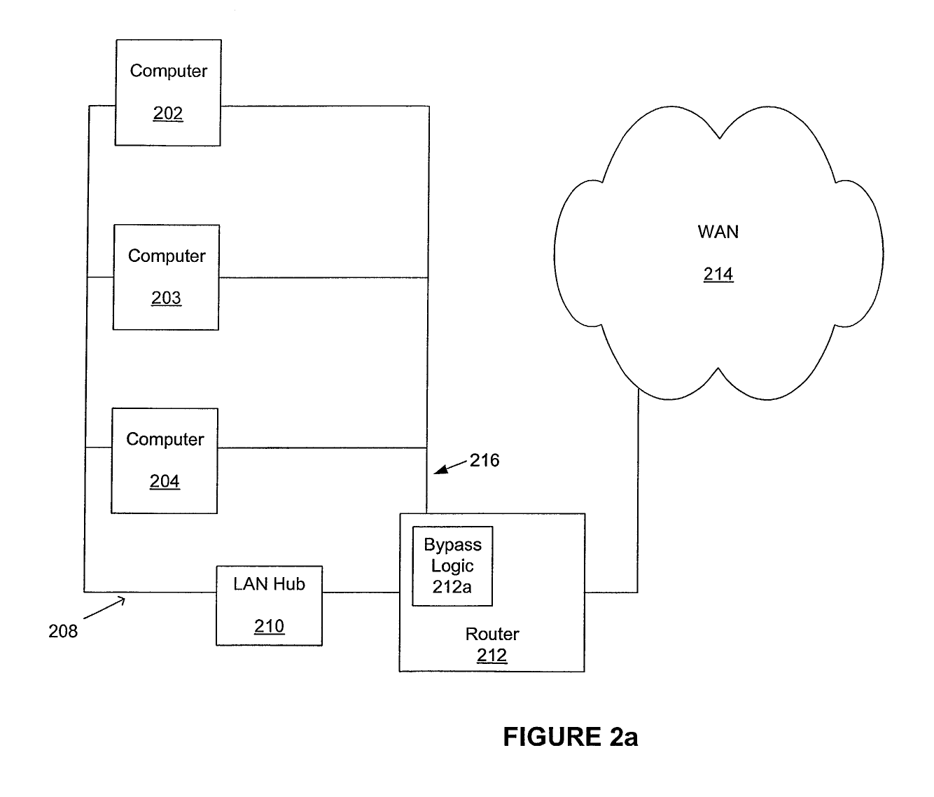

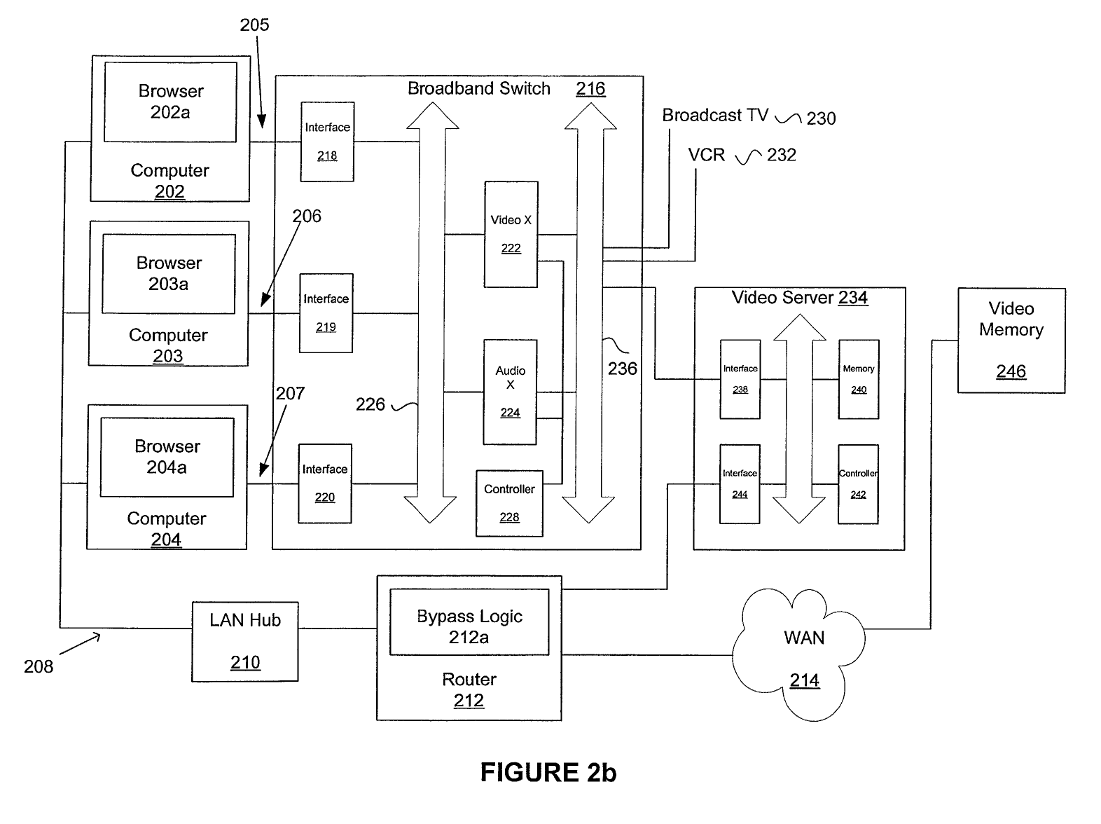

FIG. 2a shows a computer network configuration that can be used to transfer files. Computers 202-204 are connected to each other through a local area network (LAN) 208. Computers 202-204 can be desktop computers, laptop computers, personal digital assistants or any other computer devices that can perform the functions described below. A LAN hub 210 connects the computers to a router 212. Computers 202-204, LAN 208 and LAN hub 210 are conventional components known to those skilled in the art. Router 212 connects LAN hub 210 to a wide area network (WAN) 214. WAN 214 may be the Internet or any other network used to connect remote computers or LANs.

Router 212 includes a bypass logic module 212a that can route digital files received from WAN 214 to computers either over LAN 208 or alternate path 216. An example of an alternate path 216 will be described below with reference to FIG. 2b. Bypass logic module 212a can be programmed to recognize which files to transmit across LAN and which files to transmit across alternate path 216.

FIG. 2b illustrates an embodiment showing a broadband switch 216 and video server 234 located between router 212 and computers 202-204. Broadband switch 216 includes a plurality of interface units 218-220 that can convert data received from computers 202-204 into a format that can be used by the other modules within broadband switch 216. The type of interface units utilized may be a function of the type of transmission lines 205-207 used to connect computers 202-204 to interface units 218-220. When broadband lines, such as coaxial cables, are used as transmission lines 205-207, interface units 218-220 may comprise broadband modems. Furthermore, when ordinary telephone lines are used as transmission lines 205-207, each interface unit 218-220 may comprise a video modem of the type disclosed in U.S. Pat. No. 5,621,455 (the entire disclosure of which is hereby incorporated by reference) with corresponding video modems located at the other ends of transmission lines 205-207 and connected to computers 202-204. The video modems disclosed in U.S. Pat. No. 5,621,455 provide for modulation and demodulation of video and high quality audio data over ordinary telephone wires without disrupting existing telephone communications. Broadband switch 216 can also be connected to a telephone switch (not shown) in the manner described in U.S. patent application ser. No. 08/777,881.

As shown in FIG. 2b, broadband switch 216 also includes a video crosspoint switch 222 and audio crosspoint switch 224. Switches 222 and 224 can be coupled to each interface unit 218-220 such that computers 202-204 are coupled to one another to facilitate video conferencing between computers 202-204. Although this switching arrangement is shown as using a bus 226 in FIG. 2b, the crosspoint switches can instead be directly wired to each interface unit. Moreover, although the crosspoint switches are shown as separate units, they can of course be combined into a single switch. Finally, multiple interface units could be combined into a single plug-in card to fit in a chassis.

Broadband switch 216 also includes a controller 228 for controlling the overall operation of the switch and, in particular, commanding crosspoint switches 222 and 224. FIG. 2b shows three separate video sources coupled to video cross point switch 222 and audio cross point switch 224. In particular, a broadcast TV signal 230, a VCR signal 232 and the output of a video server 234 are coupled to a bus 236. Additional or alternative video sources can also be included. Furthermore, analog to digital converters (not shown) can be included between any analog video sources and bus 236. Controller 228 operates to connect each interface unit 218-220 to one or more of the other interface units or video signals.

Video server 234 can also be located between computers 202-204 and router 212. Alternatively, broadband switch 216 can be directly connected to router 212. Video server 234 can be a computer based server that stores and retrieves video files. An interface unit 238 couples video server 234 to broadband switch 216. Video files may be stored within a memory 240, which can be located within or coupled to video server 234. In one embodiment of the invention, memory 240 is implemented with a RAID disk array. Furthermore, memory 240 can be implemented with more than one memory and can include read only memory (ROM) elements. A controller 242 controls the operation of video server 234 including, for example, video processing steps, such as decompressing and processing MPEG videos. The use of controller 242 to perform video processing steps reduces the processing requirements of computers 202-204. In one alternative embodiment, video server 234 is coupled to broadband switch 216 in a manner that allows controller 228 to control the operation of video server 234. Furthermore, some or all of the components comprising video server 234 can be included within broadband switch 216.

Each computer 202-204 can request a video file stored in memory 240. For example, each computer 202-204 can include video application software that can transmit such a request to controller 228, which can then transmit a corresponding request through interface unit 238, to controller 242. The request can include an identification of the file and the identification of a route back to the requesting computer. Controller 242 can then cause the appropriate video file to be retrieved from memory 240 and transmitted back to the requesting computer over the requested route.

The use of video server 234 to retrieve video files stored on another computer will now be described. Each computer 202-204 can include software that allows the user to download video files stored on a remote computer via LAN 208 or video server 234. When the user requests that a file be transmitted via video server 234, the request is transmitted from one of computers 202-204 to controller 242 in the manner described above. However, instead of retrieving the file from memory 240, controller 242 sends the request through an interface unit 244 to router 212. Router 212 can then retrieve the file in a conventional manner and transmit the file to video server 234. For example, a video file can be retrieved from a video memory 246 and can be transmitted across WAN 214 to router 212. Video memory 246 can be located within a conventional server, video server or any other computer device connected to WAN 214. Router 212 can then transmit the file to video server 234. Video server 234 can then store the file in memory 240 or transmit the file to one of computers 202-204.

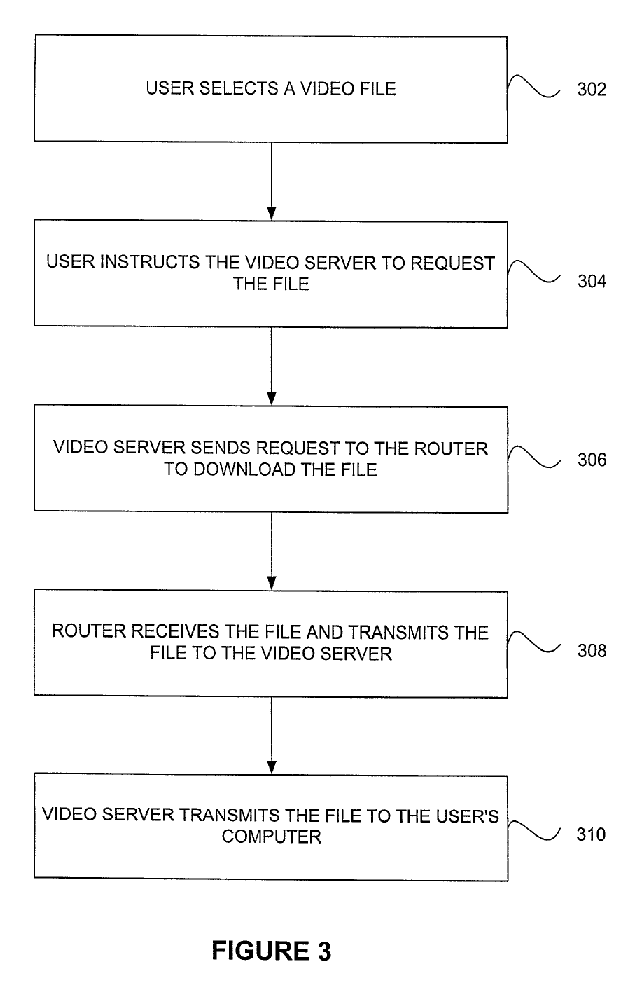

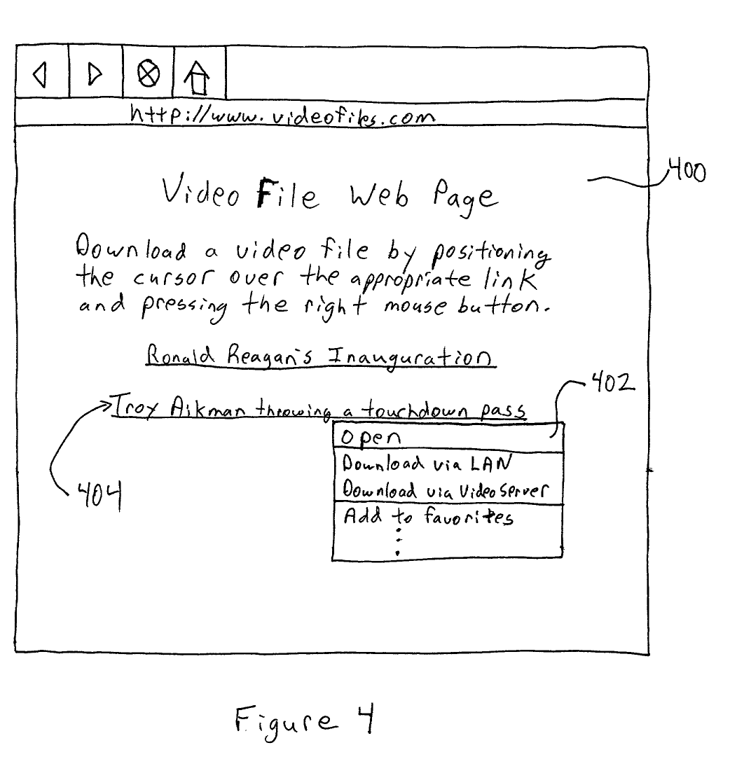

FIG. 3 shows a method of requesting video files via video server 234 in accordance with an embodiment of the invention. In step 302, the user selects a video file. Each computer 202-204 can include a browser 202a-204a for interfacing with WAN 214. Examples of suitable browsers include Netscape Communicator and Microsoft Internet Explorer. The user can use the browser to select a video file to download. FIG. 4 shows an example in which the user uses a browser to view a video file web page 400 that may be located on the Internet.

In step 304, the user instructs video server 234 to request the file. FIG. 4 shows an embodiment in which the user can make such a request by making the appropriate selection in a drop down menu 402. Drop down menu 402 appears when the user selects a right mouse button while a cursor is positioned over entry 404 and include a first option for downloading the selected video file via a LAN and a second option for downloading the video file via an alternative path. The software for implementing drop down menu 402 can be in the form of a plug-in addition to browsers 202a-204a, an ActiveX control or any other software code that allows the user to make such a selection.

Video server 234 sends the file request to router 212 in step 306. Each computer 202-204 is assigned a unique Internet protocol (IP) address. Video server 234 is also assigned an IP address. The request from video server 234 includes the IP address of the video server. Next, in step 308, router 212 requests the file from video memory 246 and transmits the file to video server 234. Router 214 requests the file in a conventional manner, such as over the Internet. After receiving the file, router 212 transmits the file to the IP address of video server 234, thus bypassing LAN 208.

In step 310, video server 234 transmits the requested file to the user's computer or informs the user that the requested file has been received. There are a number of ways to inform the user. For example, the video file can be downloaded and played or video server 234 can send an instant message or e-mail message to the user. In an alternative embodiment, the user can select whether to be notified and the manner to be notified.

The method shown in FIG. 3 involves sending the request through video server 234. In another embodiment of the invention (not shown), the request is sent through LAN 208 to router 212. However, in this embodiment, the request should include the IP address of video server 234. The IP address of video server 234 may be included in the header of one of the packets comprising the request and in the header of one of the packets containing the file. Router 212 includes bypass logic software 212a for parsing through packets for proper routing. In one embodiment of the invention, router 212 receives files in the form of packets having the IP address of one of computers 202-204 as the destination address and the IP address of video server 234 included in a predefined section of the header of the packet. Bypass logic software can then determine whether an appropriate bypass IP address is included in the packet and, if so, route the packet to the bypass IP address.

Bypass logic 212a can also include logic to route files to a destination based on the size of the file. For example, files having a size of less than 5 MB can be routed to computers 202-204 through LAN 208 and files having a size greater than 5 MB can be routed to video server 234 and broadband switch 216. Furthermore, the decision regarding where to route the file can be based on factors such as the current traffic on LAN 208 or the time of day. If the LAN is not experiencing a heavy amount of traffic, the performance of the LAN is less likely to be degraded by the transfer of a large file. Furthermore, there may be times, such as 3:00 in the morning when the LAN is typically not busy. Even when files are transmitted to one of computers 202-204 through LAN 208, the user may choose to store the file in memory 240 of video server 234. Memory 240 can be larger than the memories in computers 202-204 and provides a convenient place for all of the computers to obtain access to stored files.

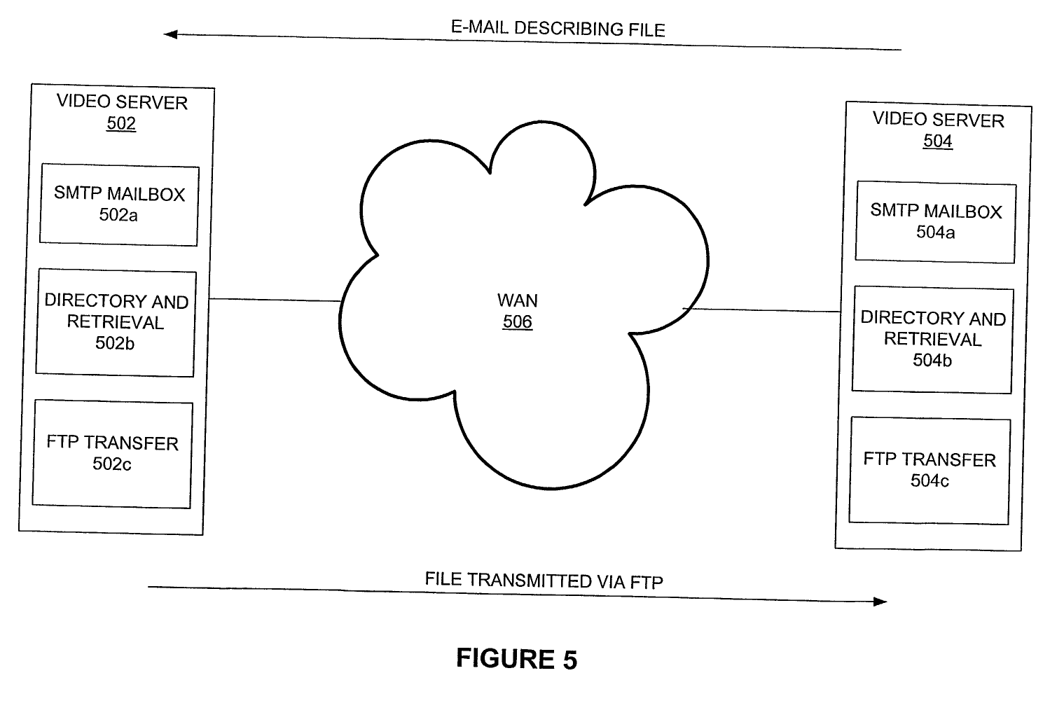

FIG. 5 shows an embodiment in which video servers 502 and 504 can transmit files to each other across WAN 506. In one embodiment, video server 504 sends an e-mail message to video server 502 to request a file. Video servers 502 and 504 can include simple mail transfer protocol (SMTP) mail boxes 502a and 504a for sending and receiving e-mail messages. The message requesting a file should include the identification of a requested file and an address of video server 504, such as an IP address. Video server 502 retrieves the requested file and transmits the file across WAN 506 to video server 504. Each video server 502 and 504 can include directory and retrieval modules 502b and 504b for finding and retrieving files. The requested file can be transmitted across WAN 506 using a file transfer protocol (FTP). Each video server can include an FTP transfer module 502c and 504c for transmitting files using FTP. FTP allows large files to be transmitted across a WAN much faster than SMTP, which is typically used when attaching files to e-mail messages. Of course, each video server 502 and 504 may include security software to control access to files stored within the video server. Two video servers 502 and 504 are shown connected to WAN 506 for illustration purposes only and with the understanding that several video servers can be connected to WAN 506. Alternatively, any number of video servers can be directly connected to one another, i.e., without an intervening WAN.

While the present invention has been described in connection with the illustrated embodiments, it will be appreciated and understood that modifications may be made without departing from the true spirit and scope of the invention. For example, the present invention is not limited to use with video files and can be used with any large files that would degrade the performance of a LAN.

What is claimed is:

1. A computer system comprising:
a first computer device that transmits requests for digital files across a first network to a server connected to a second computer device that routes digital files;
a local area network that does not include the first network and connects the first computer device to the second computer device;
wherein the second computer device receives the requested digital files and is programmed to route a first digital file to the server and to route a second digital file through at least a portion of the local area network to the first computer device.

2. The computer system of claim 1, wherein the first computer device includes computer executable instructions for allowing a user of the first computer to determine whether a digital file is a first digital file or a second digital file.

3. The computer system of claim 1, wherein the second computer device includes computer executable instructions for determining whether a digital file is a first digital file or a second digital file.

4. The computer system of claim 3, wherein the determination is based on the size of each digital file.

5. The computer system of claim 3, wherein the determination is based on a traffic condition of the local area network.

6. The computer system of claim 3, wherein the determination is based on the time of day.

7. The computer system of claim 1, wherein the first network includes a broadband switch coupled to the first computer device with an ordinary telephone line.

8. The computer network of claim 1, wherein the server is a video server that includes a module for decompressing video files.

9. A method of requesting and receiving a file from a remote source, the method comprising the steps of:
(1) transmitting via a local area network a request for the file from a first computer device to a second computer device that routes files;
(2) receiving the file at the second computer device; and
(3) transmitting the file from the second computer device to the first computer device via a path that does not include the local area network.

10. The method of claim 9, wherein the path includes a video server that stores and receives video files.

11. The method of claim 10, wherein the path further includes an ordinary telephone line.

12. A method of downloading a video file from a remote source connected to a wide area network, the method comprising the steps of:
(1) selecting a file located at the remote source connected to the wide area network;
(2) determining whether the file should be transmitted from the remote source to a first computer device via a local area network or via an alternate transmission path that does not include the local area network; and
(3) causing a second computer device to route the file in accordance with the determination made in step 2.

13. The method of claim 12, wherein the determining step comprises selecting the local area network or the alternate transmission path based on the size of each digital file.

14. The method of claim 12, wherein the determining step comprises selecting the local area network or the alternate transmission path based on a traffic condition of the local area network.

15. The method of claim 12, wherein the determining step comprises selecting the local area network or the alternate transmission path based on the time of day.

16. A method of routing a digital file to a first computer connected to a remote source via a local area network and an alternate transmission path that does not include the local area network, the method comprising the steps of:
(1) receiving a digital file at a second computer device that routes files;
(2) determining the size of the digital file;
(3) transmitting the digital file from the second computer device to the local area network when the digital file is less than a predetermined size; and
(4) transmitting the digital file from the second computer device to the first computer device via the alternate transmission path that does not include the local area network when the digital file is greater than the predetermined size.

17. A computer system comprising:
a first computer device that transmits requests for digital files across a local area network to a second computer device that routes digital files;
an alternative transmission path that does not include the local area network and connects the first computer device to the second computer device;
wherein the second computer device receives the requested digital files and is programmed to route a first digital file through the local area network to the first computer and to route a second digital file through the alternative transmission path to the first computer device.

18. The computer system of claim 17, wherein the second computer device includes computer executable instructions for determining whether a digital file is a first digital file or a second digital file.

19. The computer system of claim 18, wherein the determination is based on the size of each digital file.

20. The computer system of claim 18, wherein the determination is based on a traffic condition of the local area network.

21. The computer system of claim 18, wherein the determination is based on the time of day.

22. A computer system comprising:
a computer device that transmits a request for a digital file through an ordinary telephone line to a broadband switch;
a video server coupled to the broadband switch and that receives the request and transmits the request to a router;
a local area network that connects the computer device to the router and does not include the video server; and
wherein the router receives the requested digital file and includes computer-executable instructions for performing the steps of:
(1) determining the size of the digital file;
(2) transmitting the digital file to the local area network when the digital file is less than a predetermined size; and
(3) transmitting the digital file to the video server when the digital file is greater than the predetermined size.
